(19) United States
(12) Patent Application Publication
(10) Pub. No.: US 2013/0299094 A1
(43) Pub. Date: Nov. 14, 2013

(54) METERING SYSTEM FOR APPLYING A COMPOSITION TO A ROLL AND METHODS OF OPERATING SAME

(71) Applicant: David Raymond Henke, SR., Moscow Mills, MO (US)

(72) Inventor: David Raymond Henke, SR., Moscow Mills, MO (US)

(21) Appl. No.: 13/468,521

(22) Filed: May 10, 2012

(51) Int. Cl. B32B 37/12; B05D 5/10; B05C 3/00; B05C 11/04

(52) U.S. Cl. 156/498; 118/100; 427/207.1; 118/58; 118/600; 156/549; 156/499

(57) ABSTRACT

An adhesive metering system for applying an adhesive to an anilox roll is provided. The anilox roll includes cups embedded within a peripheral surface of the anilox roll. The system includes a pan having a first end, a second end, opposing sidewalls, and a bottom configured to form a trough to partially receive the peripheral surface. A first blade is coupled to the first end, wherein the first blade has an edge spaced from the cups by a gap defined between the peripheral surface and the edge. The system further includes a pump coupled to the pan and in flow communication with the first blade and the trough. The pump is configured to discharge the adhesive into the trough and on the first blade wherein the first blade is configured to facilitate channeling adhesive into the cups of the anilox roll.

### BACKGROUND OF THE INVENTION

The present disclosure relates generally to a metering system to apply a liquid composition to a roll, and more specifically, to methods and systems for applying an adhesive to an anilox roll.

When labeling some food packaging, ink is printed on one side of a substrate, while an adhesive is applied on an opposite side of the substrate, and then the substrate adhesive side is laminated to a film at a laminating nip roll. Currently, some water borne adhesives have replaced some solvent-based adhesives due to the reduction of emissions of noxious vapors from the solvent-based adhesives. Known water borne adhesives include urethanes, acrylics, and other hybrids. Some of these adhesives, however, can pose a health hazard when used in laminating the film to flexible packaging used for foodstuffs. Some of these adhesives can react and form unpleasant aromatic vapors which can migrate through the film and into the foodstuffs.

For labeling processes, rotary machines are used for printing or otherwise applying ink or other liquid compositions, such as the adhesive, to travelling substrates, including sheets or webs of printable material. More particularly, liquid composition is applied to a receiving roll known as an “anilox” roll, the peripheral surface of which has a variety of tiny, closely spaced, shallow depressions called “cells” or “cups”. These cups retain ink, adhesives, or other liquid compositions supplied thereto by any appropriate delivering means, such as a bath, fountain and/or a spray.

Blades, which are known as doctor blades, can be used to level and/or remove excess composition from the peripheral surface of the receiving roll. Although doctor blades assist in removing excess composition from the receiving roll, applying the liquid composition to the receiving roll is an important phase associated with labeling substrates. Metering systems are needed to controllably meter an adhesive having a sufficiently low enough viscosity at room temperature to permit even and predictable flow, wherein the adhesive does not emit noxious fumes, is not affected by moisture, where pot life is extended to a sufficient degree to increase efficiency of production, and wherein the adhesive employed in the process is deemed acceptable by the U.S. Food and Drug Administration for use in laminating packaging to be used to package food products.

### BRIEF SUMMARY OF THE INVENTION

In one aspect, an adhesive metering system for applying an adhesive to an anilox roll is provided. The anilox roll includes cups embedded within a peripheral surface of the anilox roll. The system includes a pan having a first end, a second end, opposing sidewalls, and a bottom configured to form a trough to partially receive the peripheral surface. A first blade is coupled to the first end, wherein the first blade has an edge spaced from the cups by a gap defined between the peripheral surface and the edge. The system further includes a pump coupled to the pan and in flow communication with the first blade and the trough. The pump is configured to discharge the adhesive into the trough and on the first blade wherein the first blade is configured to facilitate channeling adhesive into the cups of the anilox roll.

In another aspect, a method of metering an adhesive to a roll is provided, wherein the roll includes cups embedded within a peripheral surface of the roll. The method includes heating the adhesive and discharging the heated adhesive into a pan. The roll is partially embedded into the pan and then rotated within the adhesive. The method includes discharging the adhesive onto a blade that is coupled to the pan and orientated toward the roll and channeling the adhesive from the blade and into the cups of the roll.

In a further aspect, an adhesive application system for coupling a film web to a substrate is provided. The system includes a support roll coupled to the substrate for use in holding and dispensing the substrate. A metering system is positioned in flow communication with the support roll. The metering system includes an anilox roll having cups embedded within a peripheral surface. A pan having a first end, a second end, opposing sidewalls and a bottom is configured to form a trough to partially receive the peripheral surface. The metering system further includes a first blade coupled to the first end, wherein the first blade has an edge spaced from the cups by a gap defined between the peripheral surface and the edge. A pump is coupled to the pan and in flow communication with the first blade and the trough. The pump is configured to discharge the adhesive into the trough and on the first blade wherein the first blade is configured to facilitate channeling adhesive into the cups of the anilox roll. The anilox roll facilitates applying the adhesive to the substrate. The system further includes a film roll in flow communication with the metering system and is coupled to the film web for use in holding and dispensing the film web. A drive roll is coupled to the substrate and the film web for use in continuously coupling the film web to the adhesive disposed on the substrate.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 illustrates a side schematic view of an exemplary adhesive application system.

FIG. 2 is a side schematic view of an exemplary metering system that may be used with the adhesive application system of FIG. 1.

FIG. 3 is a partial side view of the metering system of FIG. 2.

FIG. 4 is a side schematic view of another exemplary adhesive application system.

FIG. 5 is a flowchart illustrating an exemplary method of metering an adhesive.

Although specific features of various embodiments may be shown in some drawings and not in others, this is for convenience only. Any feature of any drawing may be referenced and/or claimed in combination with any feature of any other drawing.

### DETAILED DESCRIPTION OF THE INVENTION

The embodiments described herein relate to a resilient metering process. Generally, the embodiments relate to a metering system for dispensing a liquid composition, such as, but not limited to, adhesives and inks. Moreover, the metering system is utilized to dispense liquids onto a substrate used in a variety of purposes such as, but not limited to, food, industrial, and consumer packaging. In one application, the metering system described herein is utilized to controllably dispense an adhesive to an anilox roll. It should be understood that the embodiments described herein are not limited to adhesives and anilox rolls, and further understood that the description and figures that utilize adhesives and anilox rolls are exemplary only. The present invention is compatible with known printing processes such as, but not limited to, flexographic and gravure processes, while providing a metering process that is safe and convenient to use.

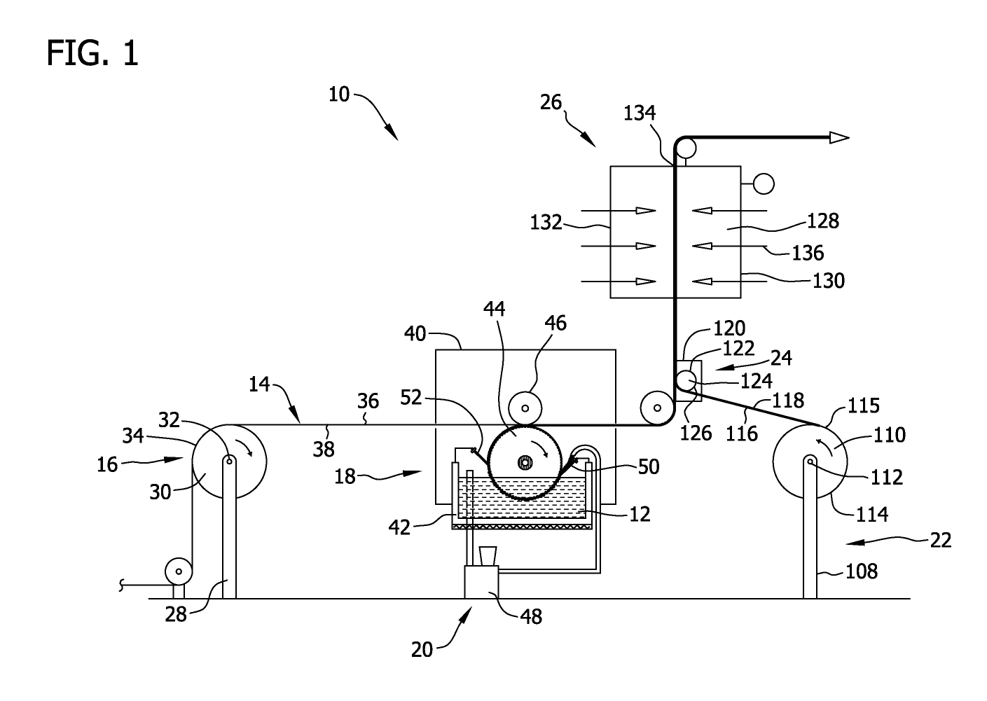

FIG. 1 illustrates a side schematic view of an exemplary adhesive application system 10 for use in applying a composition 12 to a substrate 14. Adhesive application system 10 includes a support assembly 16, a metering system 18, a pump system 20, a film assembly 22, a drive assembly 24 and a cooling system 26. System 10 can include a printing, inking, transfer, or metering roll, or any other type of roll, whether metal-faced, rubber-faced, and/or ceramic-faced, or of any other composition which is adapted to receive liquidous compositions. For subject matter described herein, liquidous composition 12 is any composition (such as an ink, ink paste, adhesive, or other composition) which is at least partly composed (including major or minor proportions) of material(s) that are liquid or at least semi-liquid under operating conditions, and which is capable of sufficient flow under such conditions to be applied to and transferred to a receiving roll to another roll and/or a substrate 14 in a manner which is controllable with respect to amount and placement. Composition 12 includes materials which are and are not liquid, and those which are and are not flowable, under ambient conditions. In the illustrated embodiment, composition 12 is an adhesive.

For the subject matter described herein, the substrate 14 is any material receptive to application of adhesive 12 from an anilox roll 44 under any practical operating conditions for the substrate 14, roll 44, and composition 12, including, for example, paper and polymeric films in the form of webs and/or sheets.

Support assembly 16 includes a frame 28 coupled to a support roll 30. Roll 30 has a longitudinal axis 32 and a peripheral surface 34 such that peripheral surface 34 is rotatably coupled to frame 28 about longitudinal axis 32. Support roll 30 is configured to support and dispense substrate 14, which has a first side 36 and a second side 38. First side 36 is exposed to inking and/or labeling processes (not shown) and second side 38 is coupled to peripheral surface 34.

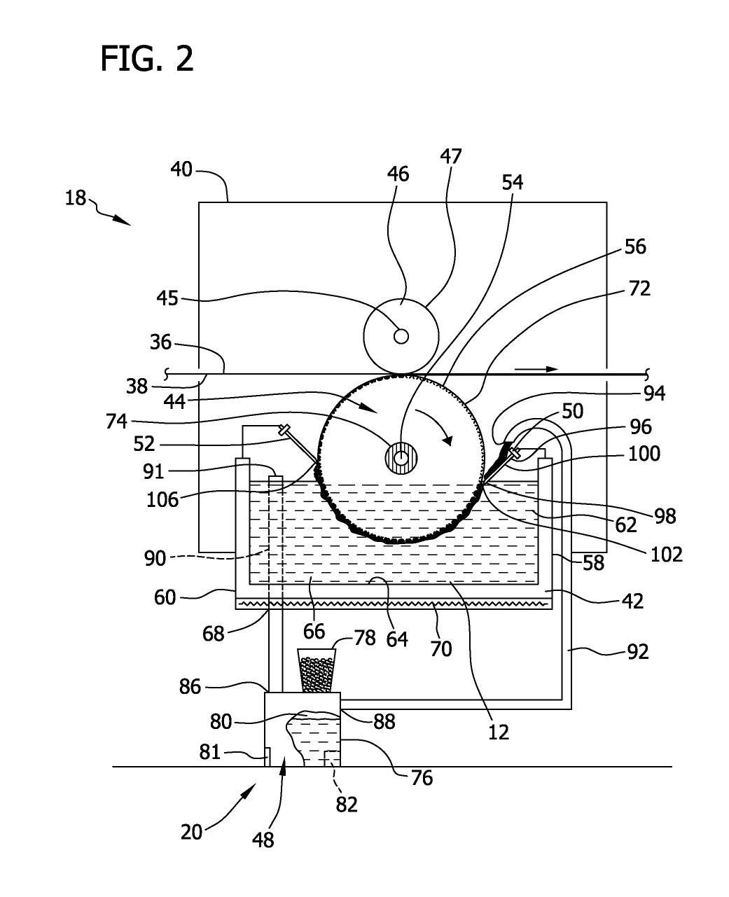

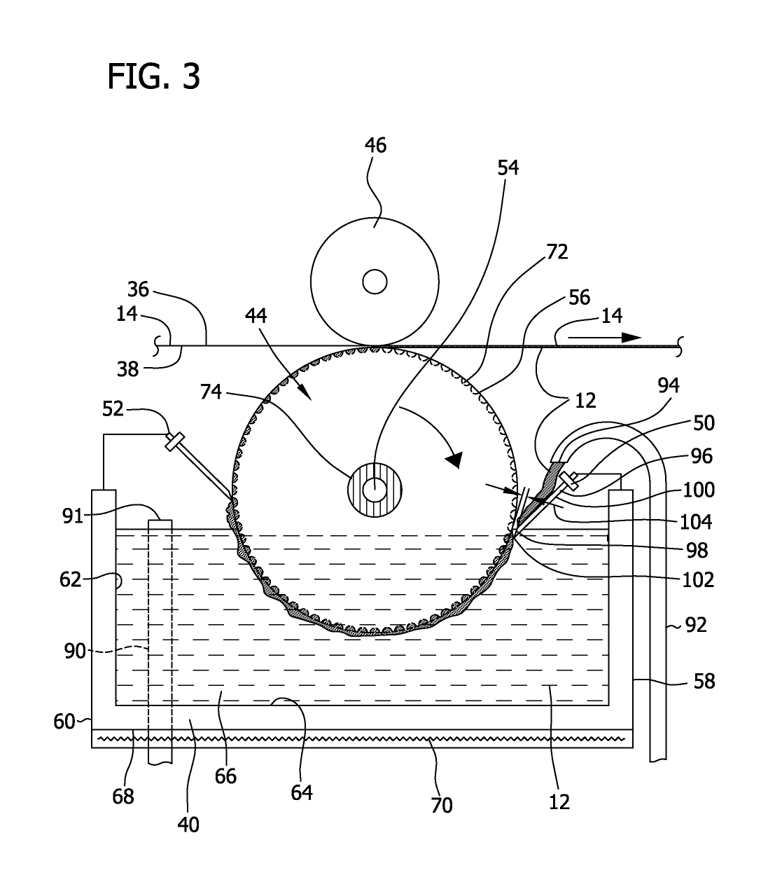

FIG. 2 is a side schematic view of metering system 18 that may be used with the adhesive application system 10 of FIG. 1. FIG. 3 is a partial view of metering system 18 of FIG. 2. Metering system 18 is positioned in flow communication with support assembly 16. Metering system 18 is configured to facilitate controllably applying adhesive 12 to anilox roll 44 and for subsequent application of adhesive 12 to substrate 14 and, in particular, second side 38 of substrate 14. In the exemplary embodiment, metering system 18 includes a frame 40, a pan 42, an anilox roll 44, a nip roll 46, a pump assembly 48, a first blade 50, and a second blade 52. Anilox roll 44 and nip roll 46 are rotatably coupled to frame 40 in positions such that anilox roll 44 is positioned adjacent to nip roll 46. Anilox roll 44 includes a longitudinal axis 54 and peripheral surface 56, and nip roll 46 includes a longitudinal axis 45 and peripheral surface 47. Rolls 44 and 46 are rotatably coupled to frame 40 to enable portions of respective peripheral surfaces 56 and 47 to contact each other. Substrate 14 is positioned between nip roll 46 and roll 44, such that first substrate side 36 contacts nip roll 46 and second substrate side 38 contacts anilox roll 44. Nip roll 46 is configured to apply pressure to substrate 14 and to anilox roll 44.

Pan 42 is coupled to frame 40 for use in holding an amount of adhesive 12 and in receiving anilox roll 44. Pan 42 includes a first end 58, a second end 60, opposing sidewalls 62, and a bottom 64 to form a trough 66. Bottom 64 includes a drain opening 68 defined therethrough. In the exemplary embodiment, metering system 18 includes a heater 70 coupled to pan 42 to facilitate heat transfer into trough 66 and adhesive 12 contained therein.

Anilox roll 44 is coupled to frame 40 such that peripheral surface 56 is rotatably coupled to frame 40 about longitudinal axis 54. In the exemplary embodiment, anilox roll 44 is configured to rotate clockwise toward first pan end 58 as represented by arrow in FIG. 1. Alternatively, anilox roll 44 is configured to rotate counter-clockwise (not shown). Peripheral surface 56 has minute, random, and/or regular depressions referred to as “cells” or “cups 72,” which receive and transport adhesive 12. For clarity, the figures illustrate only a limited number of such cups 72, it being understood that such cups 72 may be distributed over the entire peripheral surface 56 or over selected portions thereof in any desired arrangement, including for example circumferential bands or patterns corresponding to patterns in a printing roll with which anilox roll 44 cooperates.

Pump assembly 48 is coupled in flow communication to pan 42 for use in pumping adhesive 12 into trough 66. Pump assembly 48 includes a housing 76, a material feed 78, a reservoir 80, a heater 81, and a pump 82. Pump assembly 48 further includes an inlet 86, an outlet 88, a return conduit 90, and a discharge conduit 92.

Material feed 78 is coupled to housing 76 for use in receiving bulk, non-processed adhesive material and/or processed material for channeling adhesive 12 toward reservoir 80. Material feed 78 may include a grinder (not shown) to break down bulk adhesive 12 for further processing. Any reducing device may be used that facilitates breaking down bulk adhesive 12 to enable system 10 to function as described herein. Reservoir 80 is coupled in flow communication to support assembly 16 to receive and store adhesive 12. Heater 81 is coupled to reservoir 80 for use in heating adhesive 12 within reservoir 80 to a liquid state. Pump 82 is coupled to reservoir 80 for use in pumping adhesive 12 out of reservoir 80, through outlet 88, and into discharge conduit 92. A controller (not shown) such as, but not limited to, a central processing unit and/or a microprocessor facilitates automatically controlling operations of metering system 18.

Discharge conduit 92 includes a discharge end 94 positioned in flow communication with trough 66 for use in discharging adhesive 12 out of reservoir 80 and into trough 66. Adhesive 12 is discharged out of discharge end 94 at a constant and/or controlled rate of discharge. In the exemplary embodiment, discharge end 94 is adjustably positionable between anilox roll 44 and first pan end 58. Return conduit 90 is coupled in flow communication to housing 76 via inlet 86 and in flow communication with trough 66. In the exemplary embodiment, return conduit 90 includes an overflow end 91 positioned above adhesive 12 present in trough 66. Alternatively, overflow end 91 may positioned within adhesive 12 present in trough 66.

Trough 66 may include a level sensor (not shown) which senses the level of adhesive 12 within trough 66 and, when that level drops below a preset level, controller (not shown) prompts operation of pump 82 so that the level of adhesive 12 within trough 66 may be replenished to a desired level. Metering system 18 is configured to maintain viscosity of adhesive 12 up to a predetermined level such as, for example, up to about 2500 cps (centipoise). In the exemplary embodiment, metering system 18 maintains viscosity of adhesive 12 from about 1000 cps to about 1500 cps. Higher operating temperatures for the process result in shorter pot life of adhesive 12. Thus, viscosity sensor (not shown), when used, senses the viscosity of the adhesive 12 and when that viscosity exceeds a predetermined value, the user knows that it is time to stop the process and clean all adhesive 12 from system 10 before new adhesive 12 is replenished to trough 66 from pump assembly 48. As an alternative, viscosity sensor may be omitted and the user may visually inspect trough 66 and take note of thickening of the adhesive 12 evidencing increased viscosity.

In the exemplary embodiment, adhesive 12 includes parameters such as, but not limited to, solvent less to avoid the emission of VOCs, low viscosity, in the range from about 300 cps to about 1500 cps, usable at a substantially steady viscosity at a room temperature, while adhesive 12 is unaffected by moisture, cures at room temperature and also satisfies the requirements of the Federal Drug Administration.

First blade 50 is coupled to pan 42 and extends into trough 66. In the exemplary embodiment, first blade 50 is adjustably coupled to first pan end 58. In another embodiment (not shown), first blade 50 is coupled to frame 40. First blade 50 has a first end 96, a second end 98, and a body 100 located between first and second ends 96 and 98. First end 96 is angled with respect to pan 42 and in flow communication with discharge end 94 of conduit to enable first end 96 to receive adhesive 12 from discharge end 94 and direct adhesive 12 onto blade body 100 and towards second end 98.

Second end 98 is positioned adjacent to peripheral surface 56 of anilox roll 44, the peripheral surface 56 being partially submerged in adhesive 12. Second end 98 includes an edge 102 which is partially submerged within adhesive 12 present in trough 66. Alternatively, second end 98 and/or edge 102 can be positioned out of adhesive 12 present in trough 66. Regardless of positioning of second end 98 and/or edge 102 with respect to adhesive 12 present in trough 66, edge 102 is beveled shaped to facilitate channeling adhesive 12 from second end 98 and onto peripheral surface 56 and into cups 72. Alternatively, edge 102 is configured to channel adhesive 12 present in trough 66 onto peripheral surface 56 and into cups 72. Edge 102 can have any shape to enable system 10 to function as described herein. Second end 98 is spaced from peripheral surface 56 by a gap 104 defined between peripheral surface 56 and edge 102. Gap 104 is sized from about 0.0001 mm to about 30.0 mm. In the exemplary embodiment, gap 104 is sized from about 0.001 mm to about 0.3 mm. Alternatively, gap 104 can be any size to facilitate channeling adhesive 12 onto peripheral surface 56 and into cups 72. First blade 50 is selectively positioned with respect to at least one of pan 42 and anilox roll 44 to variably size gap 104 to facilitate flow of adhesive 12 into cups 72 as anilox roll 44 rotates peripheral surface 56 past first blade 50. More particularly, second end 98 is sized and shaped to facilitate channeling adhesive 12 that has been discharged from discharge end 94 of conduit 92, across gap 104 and into cups 72 of peripheral surface 56. The sizes, shapes and orientations of first blade 50 and gap 104 facilitate providing controlled and/or constant flow control for adhesive 12 from conduit 92 to peripheral surface 56 and to provide controlled and/or constant flow control of adhesive 12 into cups 72.

Second blade 52 is coupled to pan 42 for use in controlling adhesive 12 applied to peripheral surface 56 as anilox roll 44 rotates peripheral surface 56 out of trough 66. More particularly, second end 60 is configured to level and/or remove excess adhesive 12 from peripheral surface 56 of anilox roll 44. In the exemplary embodiment, second blade 52 is adjustably coupled to second pan end 60. Second blade 52 includes an edge 106 which contacts peripheral surface 56 of anilox roll 44 along a line of contact which is usually at least generally parallel to the rotation axis 54 of anilox roll 44. In the exemplary embodiment, second blade 52 is angled or canted so that edge 106 is positioned at an angle to a plane which is tangent to the peripheral surface 56 along the contact line. When peripheral surface 56 of anilox roll 44 approaches the contact line from the acute angle side, edge 106 is configured to facilitate wiping adhesive 12 applied to peripheral surface 56. More particularly, edge 106 is configured to remove and/or level adhesive 12 from peripheral surface 56 while maintaining adhesive 12 with cups 72 for subsequent application of adhesive 12 to substrate 14 as described herein. Alternatively, edge 106 can be spaced from peripheral surface 56.

Film assembly 22 is positioned in flow communication with metering system 18 and drive system 10. Film assembly 22 includes a frame 108 coupled to a film roll 110 which has a longitudinal axis 112 and a peripheral surface 114 such that peripheral surface 114 is rotatably coupled to frame 108 about longitudinal axis 112. Film roll 110 is configured to hold and dispense a film 115 which has a first side 116 and a second side 118 with a thickness between first side 116 and second side 118. Film 115 includes plastic materials such as, but not limited to, low density polyethylene. Any material can be used for film 115 to enable system 10 to function as described herein.

Drive assembly 24 is coupled to metering system 18 and film assembly 22 to facilitate coupling substrate 14 to film 115. Drive assembly 24 includes a frame 120 coupled to a nip roll 122 which has a longitudinal axis 124 and a peripheral surface 126 such that peripheral surface 126 is rotatably coupled to frame 120 about axis 124. Nip roll 122 is configured to pull substrate 14 and film 115 together. More particularly, nip roll 122 is configured to couple second side 38 of substrate 14 that has been coated with adhesive 12 to first side 116 of film 115.

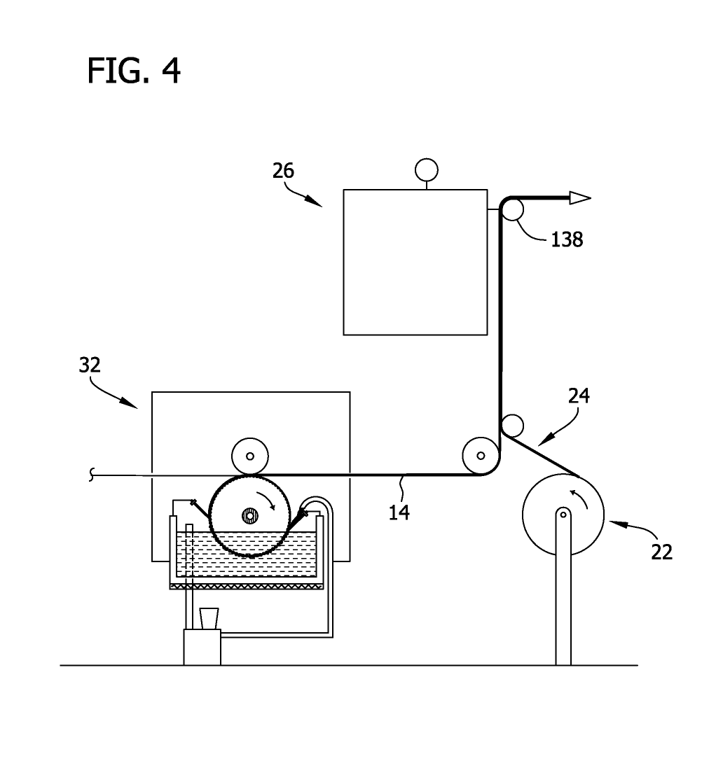

Cooling system 26 is positioned in flow communication with drive assembly 24 for use in cooling substrate 14/film 115. Cooling system 26 includes a tower 128 having a first side 130, second side 132, and a channel 134 located between first and second sides 130 and 132. Cooling system 26 further includes spray nozzles 136 coupled in flow communication to a forced air device such as a fan (not shown). Tower 128 is configured to partially surround substrate 14/film 115 to enable nozzles 136 to force air against substrate 14/film 115 to facilitate cooling of adhesive 12. FIG. 4 illustrates another exemplary adhesive application system 10, wherein cooling system 26 further includes a bypass roll 138 to enable substrate 14/film 115 to bypass cooling tower 128 if needed.

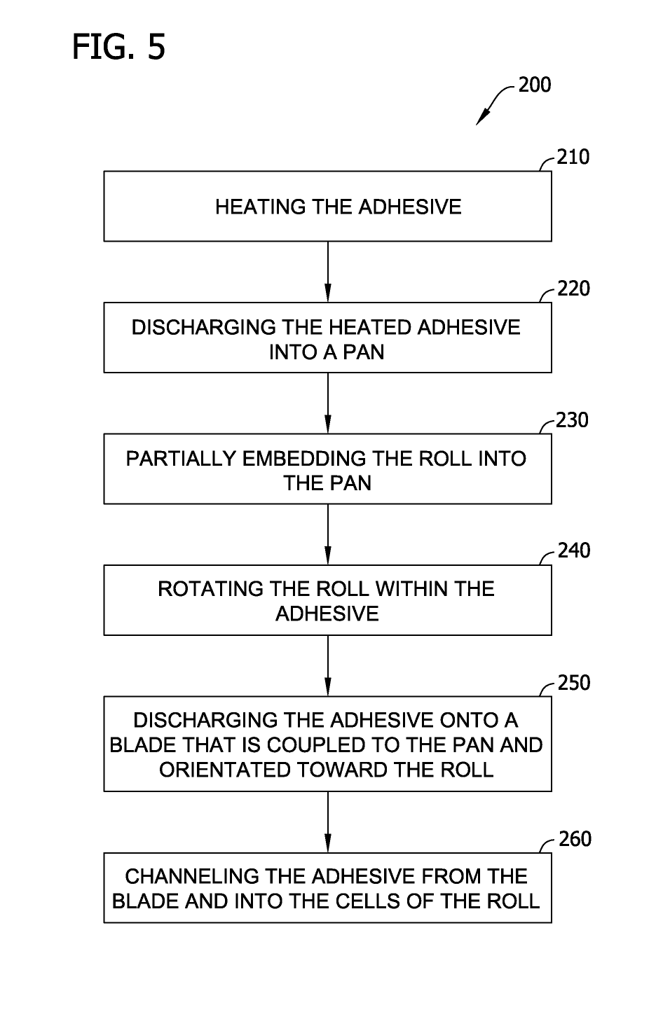

FIG. 5 is a flowchart 200 illustrating an exemplary method of metering an adhesive 12. During operation, substrate 14 is fed from support assembly 16 and through metering system 18 toward drive assembly 24 to initiate applying adhesive 12 to substrate 14. Moreover, film 115 is fed from film assembly 22 and at least through drive assembly 24 to initiate coupling film 115 to substrate 14.

To fill trough 66 with flow able adhesive 12, bulk adhesive 12 is fed into material feed 78 which channels adhesive 12 into reservoir 80. Reservoir 80 is configured to accept and store adhesive 12 from material feed 78. Alternatively, bulk adhesive 12 can be directly fed into reservoir 80.

Heater 81 is activated 210 to melt adhesive 12 that is positioned in reservoir 80 into a liquid state. Pump 82 is configured to pump adhesive 12 out of reservoir 80 and through discharge conduit 92. Conduit 92 initially fills trough 66 with adhesive 12 to cover a part of peripheral surface 56 disposed within trough 66. Conduit 92 discharges 220 adhesive 12 to a level below overflow opening 91 of return conduit 90. Pump 82 is provided to pump adhesive 12 at a flow rate greater than its rate of use so that excess adhesive 12 is returned back to reservoir 80 via overflow opening 91 for re-circulation into reservoir 80 by return conduit 90. During use, adhesive 12 is supplied to trough 66 and re-circulated back to reservoir 80 and as adhesive 12 is used, the level of adhesive 12 in trough 66 is monitored and adhesive 12 is replenished as needed. Heater 81 continues to heat reservoir 80 to facilitate maintaining adhesive 12 in a liquid state in reservoir 80.

When pan 42 is filled with adhesive 12, heater 70 applies controlled heat to pan 42 to facilitate maintaining desired temperature and viscosity parameters of adhesive 12 within pan 42. The temperature and viscosity of adhesive 12 can be monitored in pan 42 and the temperature is accordingly maintained within desired temperature limits by heater 70. Moreover, viscosity may be monitored automatically or visually so that when the viscosity exceeds desired limits, the user is notified and/or appropriate signals are generated and sent to alert the user. When adhesive 12 is pan 42 achieves its desired state, anilox roll 44 rotates to partially submerge 230 portions of peripheral surface 56 into pan 42. Anilox roll 44 continues to rotate 260 peripheral surface 56 within adhesive 12.

While anilox roll 44 rotates, discharge conduit 92 is configured to discharge 250 adhesive 12 onto first blade 50 which enables adhesive 12 to travel along body 100 toward second end 98. Edge 102 of second end 98 channels adhesive 12 under a controlled and/or constant flow across gap 104 and forces adhesive 12 into cups 72 of peripheral surface 56 as cups 72 rotate past first blade 50. Alternatively, edge 102 can direct adhesive 12 present in trough 66 into cups 72 as anilox roll 44 rotates during use. Anilox roll 44 continues to rotate to partially submerge peripheral surface 56 into adhesive 12 that is positioned in trough 66. As anilox roll 44 rotates between first blade 50 and second blade 52, adhesive 12 is applied to peripheral surface 56 and further into cups 72. While anilox roll 44 rotates within pan 42, heater 74 is configured to maintain a desired temperature of anilox roll 44 to facilitate adhesive 12 adhering to peripheral surface 56 and/or cups 72.

When anilox roll 44 rotates peripheral surface 56 out of adhesive 12, second blade 52 contacts peripheral surface 56 to facilitate leveling adhesive 12 applied to anilox roll 44. Peripheral surface 56 is then rotated in contact with second side 38 of substrate 14 which enables adhesive 12 from peripheral surface 56 and from cups 72 to be applied to second side 38. Nip roll 46 maintains a pressure force against substrate first side 36 to facilitate applying adhesive 12 to substrate second side 38.

After adhesive 12 is applied to second side 38 of substrate 14, drive assembly 24 continues to move substrate 14 past a transfer roll and toward cooling system 26. Drive assembly 24 is also configured to move film 115 towards substrate 14. Drive roll 122 couples film 115 to substrate 14. More particularly, drive roll 122 couples first side 116 of film 115 to couple to adhesive 12 present on second side 38 of substrate 14. When film 115 couples to substrate 14, drive assembly 24 continues to move substrate 14/film 115 through cooling tower 128 to facilitate cooling of adhesive 12 between substrate 14 and film 115.

Heat can be generated by friction of second blade 52 against peripheral surface 56. System 10 can include ventilation devices (not shown), including use of fans where necessary, to facilitate controlling the ambient temperature around adhesive to within narrow temperature ranges. Moreover, blades 50, 52 can include a water circulation circuit (not shown) for use as a heat exchanger (not shown) to facilitate transferring heat away from the water as it is circulated through blades 50, 52.

Exemplary embodiments of systems and methods for using adhesive application are described above in detail. The systems and methods are not limited to the specific embodiments described herein, but rather, components of systems and/or steps of the method may be utilized independently and separately from other components and/or steps described herein. The disclosed dimensional ranges include all sub ranges there between. Further, tool may be fabricated from any material that enables tool to function as described herein. Each component and each method step may also be used in combination with other components and/or method steps. Although specific features of various embodiments may be shown in some drawings and not in others, this is for convenience only. Any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An adhesive metering system for applying an adhesive to an anilox roll having cups embedded within a peripheral surface of the anilox roll, said system comprising:
a pan having a first end, a second end, opposing sidewalls, and a bottom configured to form a trough to partially receive the peripheral surface;
a first blade coupled to said first end, said first blade having an edge spaced from the cups by a gap defined between the peripheral surface and said edge; and
a pump coupled to said pan and in flow communication with said first blade and said trough, said pump configured to discharge the adhesive into said trough and on said first blade wherein said first blade is configured to facilitate channeling adhesive into the cups of the anilox roll.

2. The adhesive metering system of claim 1, wherein said gap is sized from about 0.001 mm to about 0.3 mm.

3. The adhesive metering system of claim 1, wherein said edge is beveled toward the peripheral surface.

4. The adhesive metering system of claim 1, said pump is coupled in flow communication to said pan.

5. The adhesive metering system of claim 1, wherein said pump comprises an overflow conduit coupled in flow communication to said pan.

6. The adhesive metering system of claim 1, further comprising a heater coupled to said pan.

7. The adhesive metering system of claim 1, further comprising a heater coupled to said pump.

8. The adhesive metering system of claim 1, further comprising a heater coupled to said anilox roll.

9. The adhesive metering system of claim 1, further comprising a second blade coupled to said second end, said second blade comprises an edge coupled to peripheral surface.

10. The adhesive metering system of claim 1, wherein said first blade is adjustably coupled to said pan.

11. A method of metering an adhesive to a roll having cups embedded within a peripheral surface of the roll, the method comprising:
heating the adhesive;
discharging the heated adhesive into a pan;
partially embedding the roll into the pan;
rotating the roll within the adhesive;
discharging the adhesive onto a blade that is coupled to the pan and orientated toward the roll; and
channeling the adhesive from the blade and into the cups of the roll.

12. The method according to claim 11, further comprising draining the heated adhesive from the pan and into a pump.

13. The method according to claim 12, further comprising heating the adhesive within the pump.

14. The method according to claim 11, further comprising heating the pan.

15. The method according to claim 11, further comprising heating the roll.

16. An adhesive application system for coupling a film web to a substrate, said system comprising:
a support roll coupled to the substrate for use in holding and dispensing the substrate;
a metering system positioned in flow communication with said support roll, said metering system comprising:
an anilox roll having cups embedded within a peripheral surface;
a pan having a first end, a second end, opposing sidewalls and a bottom configured to form a trough to partially receive the peripheral surface;
a first blade coupled to said first end, said first blade having an edge spaced from the cups by a gap defined between the peripheral surface and said edge; and
a pump coupled to said pan and in flow communication with said first blade and the trough, said pump configured to discharge the adhesive into said trough and on said first blade wherein said first blade is configured to facilitate channeling adhesive into the cups of the anilox roll wherein the anilox roll facilitates applying the adhesive to the substrate;
a film roll in flow communication with said metering system and coupled to the film web for use in holding and dispensing the film web; and
a drive roll coupled to the substrate and the film web for use in continuously coupling the film web to the adhesive disposed on the substrate.

17. The system of claim 16, further comprising a cooling tower in flow communication with said drive roll.

18. The system of claim 16 further comprising a heater coupled to at least one of said anilox roll, pan and pump.

19. The system of claim 16, further comprising a second blade coupled to said second end, said second blade comprises an edge coupled to peripheral surface.

20. The system of claim 16, wherein said gap is sized from about 0.001 mm to about 0.3 mm.
